(19) United States
(12) Patent Application Publication
(10) Pub. No.: US 2022/0143606 A1
(43) Pub. Date: May 12, 2022

(54) MICROFLUIDIC DEVICES

(71) Applicant: Hewlett-Packard Development Company, L.P., Spring, TX (US)

(72) Inventors: Randall Orson Willard, Corvallis, OR (US); Jeffrey R. Pollard, Corvallis, OR (US); Alexander Govyadinov, Corvallis, OR (US); Tod Woodford, Corvallis, OR (US)

(73) Assignee: Hewlett-Packard Development Company, L.P., Spring, TX (US)

(21) Appl. No.: 17/417,428

(22) PCT Filed: Jul. 26, 2019
(86) PCT No.: PCT/US2019/043650

§ 371 Date: Jun. 23, 2021

(51) Int. Cl. B01L 3/00; G01N 21/64

(52) U.S. Cl. CPC B01L 3/502715; B01L 3/502707; G01N 21/645; B01L 2300/12; B01L 2300/168; B01L 2300/0654; B01L 2300/0645; B01L 2300/0819

(57) ABSTRACT

The present disclosure is drawn to microfluidic devices. The microfluidic device includes a substrate, an optically translucent lid, an adhesive securing the substrate to the lid, and an optical barrier material between the substrate and the optically translucent lid.

### BACKGROUND

Microfluidic devices can exploit chemical and physical properties of fluids on a microscale. These devices can be used for research, medical, and forensic applications, to name a few, to evaluate or analyze fluids using very small quantities of sample and/or reagent to interact with the sample than would otherwise be used with full-scale analysis devices or systems.

### BRIEF DESCRIPTION OF THE DRAWINGS

FIG. 1 graphically illustrates a schematic cross-sectional view of an example microfluidic device in accordance with the present disclosure;

FIG. 2 graphically illustrates a schematic cross-sectional view of an example microfluidic device in accordance with the present disclosure;

FIG. 3 graphically illustrates a schematic cross-sectional view of an example microfluidic device in accordance with the present disclosure;

FIG. 4 graphically illustrates a schematic cross-sectional view of an example microfluidic device in accordance with the present disclosure;

FIG. 5 graphically illustrates a schematic cross-sectional view of an example microfluidic device in accordance with the present disclosure;

FIG. 6 graphically illustrates a schematic cross-sectional view of an example microfluidic device in accordance with the present disclosure;

FIG. 7 graphically illustrates a schematic view of a system for conducting a fluorescing biological assay including a cross-sectional view of an example microfluidic device and a fluorescence detector in accordance with the present disclosure;

FIG. 8 is a flow diagram illustrating an example method of detecting fluorescence in accordance with the present disclosure;

FIG. 9 is a graph illustrating fluorescence from various microfluidic devices in accordance with an example of the present disclosure; and

FIG. 10 is a chart illustrating fluorescence from adhesives used in microfluidic devices in accordance with an example of the present disclosure.

### DETAILED DESCRIPTION

Microfluidic devices can be used in a variety of applications, including biotechnology, drug screening, clinical diagnostic testing, etc. However, the materials that can be used in manufacturing microfluidic devices can exhibit fluorescence and interfere with fluorescing bioassays, for example.

Methodologies used to create microfluidic devices with low to non-fluorescent backgrounds can be expensive and can prevent the ability to include semiconductor microchips in the microfluidic device in some instances.

The present disclosure is drawn to microfluidic devices, systems for conducting a fluorescing biological assay, and methods for detecting fluorescence. A microfluidic device, for example, includes a substrate, an optically translucent lid, an adhesive securing the substrate to the optically translucent lid; and an optical barrier material between the substrate and the optically translucent lid. The substrate and the lid together define a microfluidic chamber that is fluidly coupled to an inlet port and an outlet port. In one example, the optical barrier material is in the form of a thin film layer positioned between the adhesive and the lid, in the form of a particulate additive admixed in the adhesive, or a combination thereof. In another example, the thin film layer is present and is a thin film metallic layer which includes aluminum, tantalum, gold, silver, titanium, zinc, gallium, cadmium, lead, and/or alloys thereof. In another example, the thin film layer can be a thin non-metallic layer including silicon, germanium, tellurium, silicon, sulfur, AMTIR glass, or a combination thereof. In yet another example, the thin film layer is present and has an average thickness from 0.01 μm to 300 μm. In another example, a particulate additive is present and is admixed in the adhesive at a particulate additive to adhesive volume ratio of 1:1,000 to 1:5, and the particulate additive includes carbon black, doped boron nitride, polysilicon, or a mixture thereof. In one example, the microfluidic device includes multiple optical barrier materials. The multiple optical barrier materials are in the form of a thin film layer positioned between the adhesive and the lid and in the form a particulate additive admixed in the adhesive. In another example, the microfluidic device further includes a secondary thin film layer positioned between the adhesive and the substrate. In yet another example, the lid includes a non-fluorescing material selected from glass, sapphire, silica, plastic, or a combination thereof. In one example, the microfluidic device further includes a semiconductor microchip including circuitry positioned electrically to interact with fluid when introduced into the microfluidic chamber.

In another example, a system for conducting a fluorescing biological assay is presented. The system includes a microfluidic device and a fluorescence detector optically coupled to the microfluidic chamber. The microfluidic device includes a substrate, an optically translucent lid, an adhesive securing the substrate to the lid, and an optical barrier material between the substrate and the optically translucent lid. The substrate and the lid together define a microfluidic chamber. The microfluidic chamber is fluidly coupled to an inlet port and an outlet port. In one example of the system, the microfluidic chamber can be an elongated chamber having both length to width aspect ratio and a length to height aspect ratio independently from 2:1 to 200:1. In another example of the system, the fluorescence detector includes a fluorimeter, photoluminescence spectrometer, an excitation light source, optical filters, or a combination thereof.

In still another example, a method for detecting fluorescence includes loading a sample and reactants in a microfluidic device and measuring a fluorescence signal generated by positive reaction between the sample and the reactants within the microfluidic chamber. The microfluidic device includes a substrate and an optically translucent lid, an adhesive securing the substrate to the lid, and an optical barrier material between the substrate and the optically translucent lid. The substrate and the lid define a microfluidic chamber that is fluidly coupled to an inlet port and an outlet port. In one example, the optical barrier material is in the form of a thin film layer positioned between the adhesive and the lid, in the form of a particulate additive admixed in the adhesive, or a combination thereof.

It is also noted that when discussing the microfluidic devices, the systems for conducting a fluorescing biological assay, or the methods for detecting fluorescence, such discussions of one example are to be considered applicable to the other examples, whether or not they are explicitly discussed in the context of that example. Thus, in discussing an optical barrier material in the context of the microfluidic device, such disclosure is also relevant to and directly supported in the context of the system for conducting a fluorescing biological assay, the method for detecting fluorescence, and vice versa.

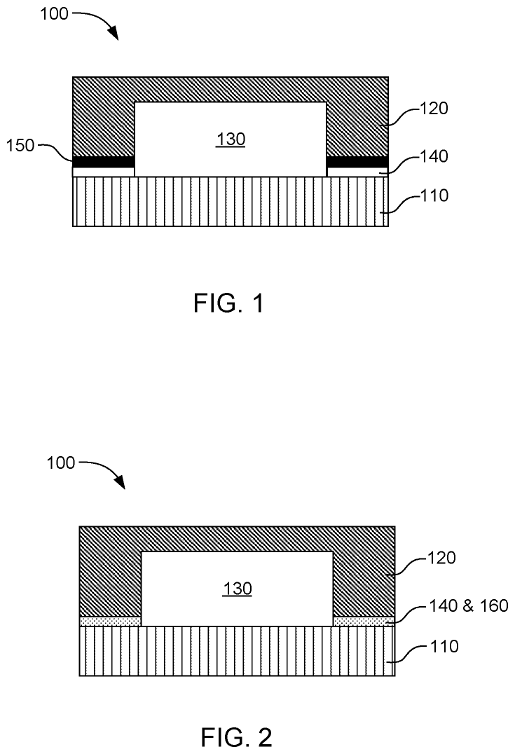

Turning now to the FIGS. for further detail, as an initial matter, there are several components of the microfluidic devices shown that are common to multiple examples, and thus, the common reference numerals are used to describe various features. Thus, a general description of a feature in the context of a specific FIG. can be relevant to the other example FIGS. shown, and as a result, individual components need not be described and then re-described in context of another FIG. In the following example descriptions, FIGS. 1-6 can be considered simultaneously in the description of the FIGS. to the extent relevant by a common reference numeral, for example.

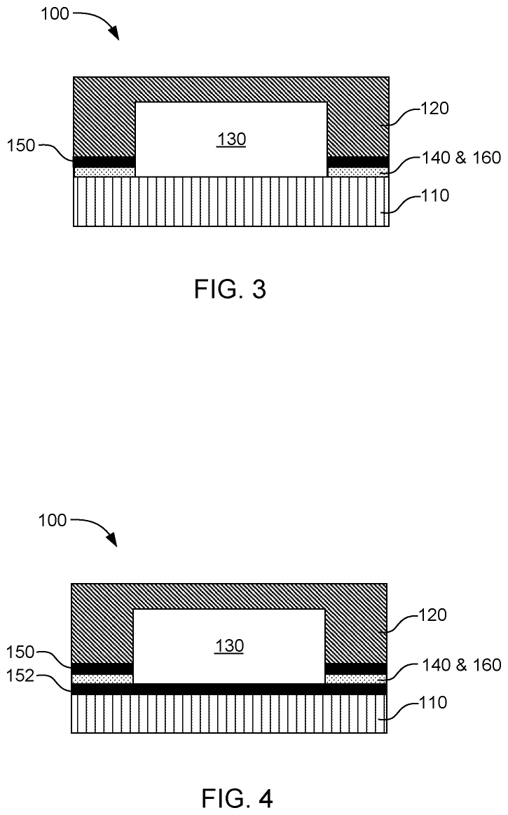

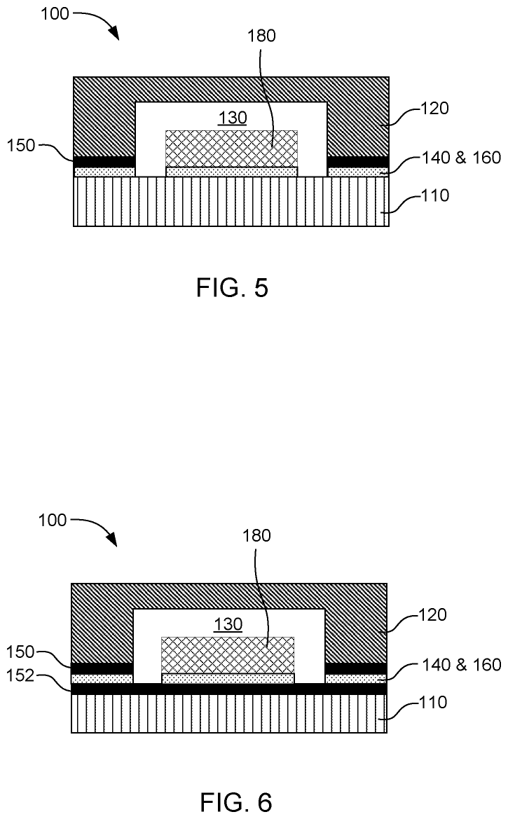

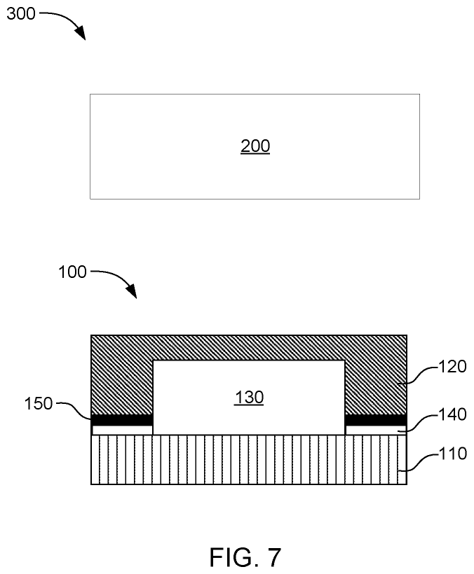

With more specific reference to FIGS. 1-6, a schematic cross-sectional view of an example microfluidic device 100 in accordance with the present disclosure are shown. As shown, the microfluidic device can include a substrate 110, an optically translucent lid 120, a microfluidic chamber 130 defined by the substrate and the optically translucent lid, an adhesive 140 securing the substrate to the lid, and an optical barrier material. The optical barrier material can include a thin film layer 150, as shown in FIG. 1, FIG. 3, FIG. 4, FIG. 5, FIG. 6, and FIG. 7. In other examples, the optical barrier material can include a second thin film layer 152, as shown in FIG. 4 and FIG. 6. In still other examples, the optical barrier material can include particulate additive 160 admixed in the adhesive as shown in FIGS. 2-6. Any combination of these arrangements of the location of the optical barrier material shown by example herein or otherwise can likewise be used. In some examples, the microfluidic device can further include a semiconductor microchip 180, as shown in FIG. 5 and FIG. 6. Notably, the adhesive shown in FIGS. 5 and 6 are shown as including the particulate additive-type of optical barrier material, though this may not be the case in other instances.

A variety of substrate materials can be used. Typically, the substrate can be any material to which an adhesive can be used to mount a lid and suitable for a desired application. In some examples, the substrate can include a material selected from glass, quartz, polyamide, polydimethylsiloxane, silicon, polystyrene, polycarbonate, polymethyl methacrylate, polyethylene, poly(ethylene glycol) diacrylate, polypropylene, perfluoroalkoxy, fluorinated ethylene propylene, polyurethane, cyclic olefin polymer, cyclic olefin copolymer, phenolics, or a combination thereof. In an example, the substrate can include polydimethylsiloxane. In another example, the substrate can include polycarbonate. In yet another example, the substrate can include polymethyl methacrylate. The substrate is not limited to non-fluorescing materials and can include materials that can exhibit fluorescence. When the substrate includes materials that exhibit fluorescence, the substrate can be covered with an optical barrier material to prevent interference from background fluorescence.

The substrate can include any variety of configurations. In one example, the substrate can be configured as a rectangle, a square, or a polygon. A thickness of the substrate can be such that a lid can be supported by the substrate.

In one example, the substrate can have a thickness that can range from 0.05 mm to 10 mm. In yet other examples, the thickness of the substrate can vary from 0.5 mm to 2 mm, from 1 mm to 5 mm, from 0.05 mm to 0.8 mm, or from 2 mm to 10 mm.

In some examples, the substrate can be configured to include an inlet port and an outlet port that can be fluidly connected to a microfluidic chamber. The inlet port and the outlet port can be used to provide fluid to (via the inlet port) and pass fluid from (via the outlet port) the microfluidic chamber. It is noted that the terms “inlet” and “outlet” do not infer that these ports interact with the microfluidic chamber in one direction, though that could be the case. In some instances, there may be occasion for the fluid to flow “backwards” or “bi-directionally,” and thus the terms “inlet port” and “outlet port” can be used because at some point during operation, these two ports act as inflow of fluid and outflow of fluid, respectively, relative to the microfluidic chamber.

The microfluidic device can further include an optically translucent lid that can be adhered to the substrate. As used herein, “optically translucent” can refer to an amount of translucency that can permit passage of light there through. In some examples, an optically translucent lid can be translucent or transparent, with translucency that can range from 30% to 100%, from 50% to 100%, from 80% to 100%, or from 90% to 100% translucent. At or near 100% translucency, e.g., 80% to 100% translucent, can be considered to be transparent for practical purposes, as the thickness of the lid can in some examples be very thin as described herein. In some examples, the optically translucent lid can include a non-fluorescing material selected from glass, sapphire, silica, plastic, or a combination thereof. In one example, the optically translucent lid can include glass. In another example, the optically translucent lid can include silica.

The lid can be any configuration suitable for contributing to forming a microfluidic chamber. For example, the lid can have a curved “U-shape,” a rectangular or square “U-shape,” a half-tubular shape or the lid can have a flat shape, with walls provided by a separate wall structure. The lid can be fitted to attach to the substrate and form a microfluidic chamber between the lid and the substrate. The lid can extend to a lateral edge of the substrate or can adhere at a point inward of the lateral edge of the substrate leaving a portion of an upper surface of the substrate exposed.

The lid can have a thickness that can vary depending on the material of the lid and the particular application for which the microfluidic device can be used. In some examples, the lid can have a thickness as measured from the microfluidic chamber to an outward surface that can range from 0.1 mm to 10 mm, from 0.1 mm to 5 mm, from 0.2 mm to 2.5 mm, from 0.5 mm to 5 mm, or from 0.3 mm to 2 mm, for example. In some examples, the lid can be designed to be relatively thin to provide greater optical transparency than would be provided by a thicker lid of the same material (depending on the material, etc.) or to provide heat dissipation from the microfluidic chamber. When a thinner lid is used, the lid can have a thickness that can range from 0.1 mm to 1 mm or from 0.1 mm to 0.5 mm, for example.

In some examples, the lid can include an inlet port and an outlet port that can be fluidly connected to a microfluidic chamber. As before, “inlet” and “outlet” do not infer that these ports interact with the microfluidic chamber in one direction. The positioning of the inlet port and/or outlet port is not limited, except that the inlet port and the outlet port can be positioned so that fluid flow (at some point in time) flows through the microfluidic chamber. In some examples, the lid can provide other ports, such as vents or other structures for facilitating fluid flow through a microfluidic chamber.

The substrate and the lid together can define a microfluidic chamber. In some examples, the microfluidic chamber can also be defined by a portion of a surface of a semiconductor microchip. The dimensions of the microfluidic chamber can vary based on desired application. The microfluidic chamber can have a width at the widest cross-sectional area that can range from 0.5 mm to 5 mm. The cross-sectional area can be defined as the area that is perpendicular to fluid flow when the microfluidic device is in operation.

In an example, the microfluidic chamber can have a length that can range from 2 mm to 75 mm. In yet other examples the microfluidic chamber can have a length that can range from 10 mm to 30 mm, from 2 mm to 5 mm, from 4 mm to 20 mm, or from 25 mm to 75 mm. In one example, the microfluidic chamber can be an elongated chamber that can have a length to width aspect ratio and a length to height aspect ratio from 2:1 to 200:1. In yet another example, the microfluidic chamber can be an elongated chamber that can have a length to width aspect ratio and a length to height aspect ratio from 3:1 to 200:1. In other examples, the structure may not be elongated, and thus can have a length to width and/or a length to height aspect ratio from 1:1 to less than 2:1.

The microfluidic chamber can be fluidly coupled to an inlet port and an outlet port. The microfluidic chamber can have a larger cross-sectional area than the inlet port or the outlet port. In yet other examples, the microfluidic chamber can have a smaller cross-sectional area than the inlet and/or outlet port.

Turning now to the adhesive, the adhesive can include polyvinyl acetate, phenol formaldehyde, ethylene vinyl acetate, cyanoacrylate, nitrocellulose, thioline-based resin, epoxy resin, SU-8, parylene, amino silane, epoxy silane, polyimide, polyester resin, polyurethane resin, acrylic, or a combination thereof. In one example, the adhesive can include an epoxy, an acrylic, or a combination thereof. In some examples, the adhesive can include aromatic rings. In other examples, the adhesive can include initiators.

The adhesive can be applied as a layer that can have a thickness that can range from 2 μm to 150 μm. In other examples, the adhesive can be applied as a layer that can have a thickness ranging from 50 μm to 150 μm, from 2 μm to 8 μm, from 5 μm to 25 μm, from 75 μm to 100 μm, or from 15 μm to 100 μm. In some examples, the adhesive can be applied at a thickness such that adhesive can be susceptible to squish and can result in exposed adhesive beads in areas outside of the adjoining surface between the substrate and the lid.

Adhesives that can be used in microfluidic devices can exhibit fluorescence due to their chemical structure. For example, the chemical structure can include aromatic rings, initiators, or the like. In addition, adhesives can include components such as fillers, tougheners, adhesion promotors, or the like that can contribute to fluorescence. Fluorescence from an adhesive can interfere with fluorescing bioassays. For example, fluorescence can result in light pollution and decrease a limit of detection and detection resolution in fluorescing bioassays. Further adhesives can mask target wavelengths thereby preventing the detection of a fluorescent signal generated by a positive reaction between a fluid sample and reactants in the microfluidic chamber.

The microfluidic device can further include an optical barrier material that can mask fluorescence interference from an adhesive and/or a substrate material. In one example, the optical barrier material can include a thin film layer positioned between the adhesive and the lid, a particulate additive admixed in the adhesive, or a combination thereof. For example, a thin film layer 150 can be positioned between the adhesive and the lid as illustrated in FIGS. 1 and 3-7. In some examples, the optical barrier material can include both a thin film layer and a secondary thin film layer 152 as illustrated in FIGS. 4 and 6. In yet other examples, the optical barrier material can include a particulate additive admixed with an adhesive 160 as illustrated as dots in FIGS. 2-6. In some examples, the optical barrier material can include both a thin film layer 150 and a particulate additive admixed with an adhesive 160 as illustrated in FIGS. 3-6. In yet other examples, the optical barrier material can include a thin film layer 150, a secondary thin film layer 152, and a particulate additive admixed with an adhesive 160 as illustrated as dots in FIGS. 4 and 6.

A thin film layer, a secondary thin film layer, or both can include any material capable of blocking excitation light by reflection or absorption and that does not fluoresce as a result of absorbing excitation light. In one example, a thin film layer is a thin film metallic layer and can include a metal selected from aluminum, tantalum, gold, silver, titanium, zinc, gallium, cadmium, lead, or a combination or alloy thereof. The alloys can be with other metals and/or can be alloys with other non-metals (including metalloids and/or semi-metals) and still be considered to be a metallic layer, e.g., lead (IV) sulfide, germanium-silicon, gallium-arsenic, zinc-selenide, etc. In one example, the thin film metallic layer can include aluminum. In another example, the thin film metallic layer can include tantalum. In some examples, the thin film metallic layer can include a reflective material. A reflective thin film metallic layer can have an increased benefit of reflecting a fluorescence signal generated by a positive reaction between a sample and reactants in a microfluidic chamber and can enhance detection of the positive reaction. In yet other examples, the thin film layer can be a non-metallic thin film layer. As used herein, non-metallic refers to non-metals, but can include semi-metals, metalloids, elements that may exhibit non-metal properties under certain conditions etc. Examples of materials that can be present in non-metallic thin film layers include, for example, silicon, germanium, tellurium, silicon, sulfur, AMTIR glass, or a combination or alloy thereof.

The thin film layer can be applied to the substrate or the lid via a vapor or sputter deposition process. In some examples, a thin film layer can be applied at a thickness that can range from 0.01 μm to 300 μm. In yet other examples, a thin film layer can be applied at a thickness that can range from 0.05 μm to 50 μm, from 0.1 μm to 100 μm, from 1 μm to 250 μm, or from 50 μm to 300 μm.

In some examples, the optical barrier material can be in the form of a particulate additive admixed with the adhesive. The particulate additive can include a non-fluorescing particulate filler. In some examples, the particulate additive can include a fluorescing quenching material. Examples of additives can include carbon black, doped boron nitride, polysilicon, or a mixture thereof. In one example, the additive can include carbon black. In another example, the additive can include doped boron nitride.

The additive can be admixed with the adhesive at a weight percentage that can range from 0.001 wt % to 6 wt %, at from 0.1 wt % to 2 wt %, from 0.5 wt % to 1.5 wt %, from 1 wt % to 3 wt %, from 0.01 wt % to 1 wt %, or from 0.01 wt % to 2 wt %. In some examples, the particulate additive can be admixed at a particulate additive to adhesive volume ratio of 1:1,000 to 1:5. In other examples, the particulate additive can be admixed at a particulate additive to adhesive volume ratio of 1:500 to 1:7, from 1:200 to 1:9, from 1:500 to 1:20, or from 1:250 to 1:30.

In some examples, the microfluidic device can further include a semiconductor microchip. In some examples, the semiconductor microchip can be substantially disposed above the substrate. However, in some examples, the semiconductor microchip, or a portion thereof, can be embedded within the substrate such that a lesser portion of the microchip extends above the substrate. In some further examples, the microchip does not extend above the substrate, but a portion (e.g., a single surface or portion of a surface) of the microchip is exposed to interact with a fluid introduced into the discrete microfluidic chamber. The semiconductor microchip can include any non-fluorescing material. For example, the semiconductor microchip can include silicon, quartz, ceramic, gallium arsenide, indium gallium nitride, gallium phosphide, aluminum gallium arsenide, germanium, silicon-germanium, or the like. In one example, the semiconductor microchip can include silicon.

In one example, the semiconductor microchip can be sized to fit in the space provided between the lid and the substrate and can be sized to permit fluid flow in the microfluidic chamber. In one example, the semiconductor microchip can be an elongated semiconductor microchip. By “elongated semiconductor microchip,” it is to be understood that the semiconductor microchip can have a width to length ratio where the width is narrower than the length. Example aspect ratios include length to width ratios such as 1:1 to 1:200, from 2:1 to 200:1, from 1:10 to 1:150, from 1:10 to 1:100, from 1:10 to 1:50, or from 1:20 to 1:00, for example. If it is an elongated structure, the aspect ratio can be from 2:1 to 200:1, for example. If it is not an elongated structure, the aspect ratio can be from 1:1 to less than 2:1, for example. The length of the semiconductor microchip can be, for example, from 1.5 mm to 50 mm, from 5 mm to 50 mm, from 10 mm to 40 mm, from 10 mm to 30 mm, from 15 mm to 50 mm, from 20 mm to 50 mm, or from 15 mm to 40 mm, for example. The width of the semiconductor microchip can be, for example, from 50 μm to 1 mm, from 100 μm to 1 mm, from 200 μm to 1 mm, from 500 μm to 1 mm, from 200 μm to 800 μm, or from 300 μm to 700 μm, for example. However, in other examples, the microchip is not an elongated microchip such that the microchip can be substantially square, circular, or otherwise fall outside of the aspect ratio described above.

There can also be a thickness component to the ratio. Thickness for the semiconductor microchip can vary, but can be thin enough to leave space in the microfluidic chamber to allow for fluid flow through the microfluidic chamber and in communication with active circuitry in the semiconductor microchip. The thickness of the semiconductor microchip can be, for example, from 50 μm to 1 mm, from 100 μm to 1 mm, from 200 μm to 1 mm, from 500 μm to 1 mm, from 200 μm to 800 μm, or from 300 μm to 700 μm, for example.

In examples herein, a top surface (or portion thereof) of the semiconductor microchip can be in contact with a fluid when loaded within the microfluidic chamber, but in some examples, there can also be sides of the semiconductor microchip that can be in contact with the fluid as well. It is noted that in referring to a structure using a term such as “top,” “side,” or “bottom,” these are considered to be relative terms that do not infer orientation, as the devices can be used in any orientation. Thus, the term “top” for example, is a term indicating location or a surface relative to a substrate to which the semiconductor microchip is supported.

The semiconductor microchip can include circuitry that can be positioned to interact with a fluid when a fluid is located in the microfluidic chamber. The circuitry can be operable to interact with or measure a quality of a fluid. For example, the circuitry can include resistors, transistors, capacitors, inductors, diodes, light emitting diodes, transistors, converters, conductive wires, conductive tracers, photosensitive components, thermal sensitive components, and the like. In some examples, the circuitry can operate as a heater (e.g., rapid thermal cycling heater, resistive heater, etc.), a sensor (e.g., photo sensor, thermal sensor, fluid flow sensor, chemical sensor, etc.), an electromagnetic radiation source (photo diode, laser, etc.), a fluid actuator (e.g., mixers, bubblers, pumps, etc.), or the like.

The circuitry can be in electrical communication with circuity or other components outside of the microfluidic chamber via a wire, a trace, a network of wires, a network of traces, an electrode, a conductive pad, and/or any other electrical communication structure that may or may not be embedded in the semiconductor microchip.

In some examples, the microfluidic device can be configured as a sliver capillary device. In other examples, the microfluidic device can be configured as a micro-reactor assembly. For example, the microfluidic device can be configured as a PCR micro-reactor. In yet other examples, the microfluidic device can be configured as part of a lab on chip device.

The microfluidic device presented herein can be utilized for fluorescing biological assays. Examples of fluorescing biological assays can include nucleic acid micro-assays, bio-sensing assays, cell assays, PCR, drug delivery research, energy transfer-based assays, fluorescence in situ hybridization (FISH), fluorescent reporter assays, fluorescent spectroscopy, quantum dot detection of cancer markers/cells, detection of reaction oxygen species, protein interactions, prion research, detection of viral antigens, detection of pathogens, detection of toxins, protein/immunological assays, chemi-fluorescent enzyme-linked immunosorbent assays (ELISA), antibody micro-assays, protein micro-assays, glycine/lectin assays, and the like for example.

In accordance with yet other examples, as shown in FIG. 7, a system 300 for conducting a fluorescing biological assay is illustrated by example. The system can include a microfluidic device 100 and a fluorescence detector 200. The microfluidic device can be any of the microfluidic devices as shown and described with reference to FIGS. 1-6 above, or any other similar configuration, but in this example, the device includes a substrate 110, an optically translucent lid 120, an adhesive 140 securing the substrate to the lid, and an optical barrier material. In this example, the optical barrier material as illustrated in FIG. 7 can include a thin film layer 150. The substrate and the lid of the microfluidic device can collectively define a microfluidic chamber 130. The microfluidic chamber can be fluidly coupled to an inlet port and an outlet port (not illustrated). The fluorescence detector can be optically coupled to the microfluidic chamber. In one example, the microfluidic chamber can be an elongated chamber having both a length to width aspect ratio and a length to height aspect ratio from 2:1 to 200:1, from 3:1 to 200:1, from 50:1 to 150:1, or from 100:1 to 200:1, for example.

Turning now to the fluorescence detector 200 in further detail, the detector can include any detector operable to measure fluorescence. In one example, the fluorescence detector can include a fluorimeter, a photoluminescence spectrometer, an excitation light source, an optical filter, or a combination thereof. In yet other examples, the fluorescence detector can include a spectrophotometer. In one example, the fluorescence detector can include an industrial fluorescent microscope, a con-focal fluorescence imaging device, or a single spot multi-excitation and fluorescent multi-label detectors with corresponding bandpass and dichroic filters and mirrors.

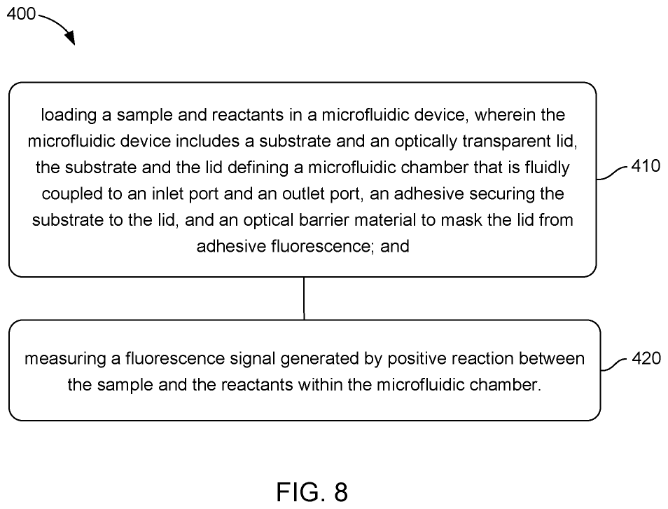

As shown in FIG. 8, a method of detecting fluorescence 400 can include loading 410 a sample and reactants in a microfluidic device and measuring 420 a fluorescence signal generated by positive reaction between the sample and the reactants. The microfluidic device can include a substrate, an optically translucent lid, an adhesive securing the substrate to the lid, and an optical barrier material. The substrate and the lid can define a microfluidic chamber that can be fluidly coupled to an inlet port and an outlet port. The substrate and the lid define a microfluidic chamber that is fluidly coupled to an inlet port and an outlet port. In one example, the optical barrier material is in the form of a thin film layer positioned between the adhesive and the lid, in the form of a particulate additive admixed in the adhesive, or a combination thereof. In an example, the background fluorescence can be reduced to enable detection of fluorescence that would be below the detection limits of a device that excludes the optical barrier material. For example, the limit of detection can increase by two orders of magnitude by adding the optical barrier materials in some instances. Other details related to this method include those described elsewhere herein in detail pertaining to the devices and systems herein.

It is noted that, as used in this specification and the appended claims, the singular forms “a,” “an,” and “the” include plural referents unless the content clearly dictates otherwise.

As used herein, a plurality of items, structural elements, compositional elements, and/or materials may be presented in a common list for convenience. However, these lists should be construed as though members of the list are individually identified as separate and unique members. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if numerical values and sub-ranges are explicitly recited. For example, a weight ratio range of 1 wt % to 20 wt % should be interpreted to include not only the explicitly recited limits of 1 wt % and 20 wt %, but also to include individual weights such as 2 wt %, 11 wt %, 14 wt %, and sub-ranges such as 10 wt % to 20 wt %, 5 wt % to 15 wt %, etc.

### EXAMPLES

The following illustrates several examples of the present disclosure. However, it is to be understood that the following are only illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1

Four microfluidic devices were created. The base microfluidic devices and control included a 1.5 mm thick substrate composed of FMID and a u-shaped lid formed from glass and having a cross-sectional thickness from the microfluidic chamber to the exterior of 200 μm. The substrate and lid were adhered with Engineered Material System's (EMS) 700-1 adhesive commercially available from Engineered Materials Systems, Inc. (USA). In one example, microfluidic device A included the components of the base device and further included a 0.2 μm thick aluminum layer over the adhesive. The layered arrangement of device A was in accordance with the device illustrated in FIG. 1.

In a second example, microfluidic device B included the base device and further included a 0.2 μm thick aluminum layer over the adhesive and 5.0 wt % particulate carbon black admixed with 95 wt % of the adhesive. The layered arrangement of device B was in accordance with the device illustrated in FIG. 3. In a further example, microfluidic device C included the components of the base device and further included a 0.2 μm thick aluminum layer over the adhesive, 5.0 wt % particulate carbon black admixed with 95 wt % of the adhesive, and second 0.2 pm thick aluminum layer under the adhesive and over the substrate. The layered arrangement of device C was in accordance with the device illustrated in FIG. 4.

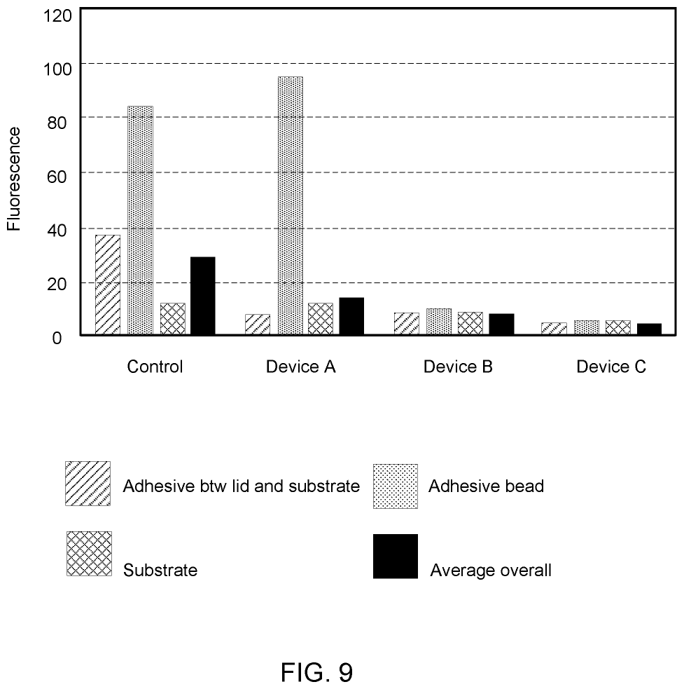

Background fluorescence of the various devices was qualitatively measured using an industrial confocal fluorescent Leica microscope. The fluorescence detector included an excitation light source to stimulate a fluorophore, optical components, such as lenses to direct light towards the fluorophore, and an optical detector to detect the light emitted by the fluorophore at a wavelength that differs from that emitted by the excitation light source. The fluorescence was measured at the location of the adhesive between the lid and substrate, at the substrate, at a bead of adhesive over the substrate, and averaged for the devices overall. Background fluorescence was decreased by orders of magnitude with optical barrier materials used in the device as illustrated in FIG. 9.

### Example 2

Two devices were created. The devices included a 1.5 mm thick substrate composed of FMID with a capillary channel engraved therein and an adhesive strip applied with Engineered Material System's (EMS) 700-1 adhesive commercially available from Engineered Materials Systems, Inc. (USA). In one example, 2 wt % particulate carbon black was admixed with 98 wt % of the adhesive prior to placing the adhesive in the capillary channel.

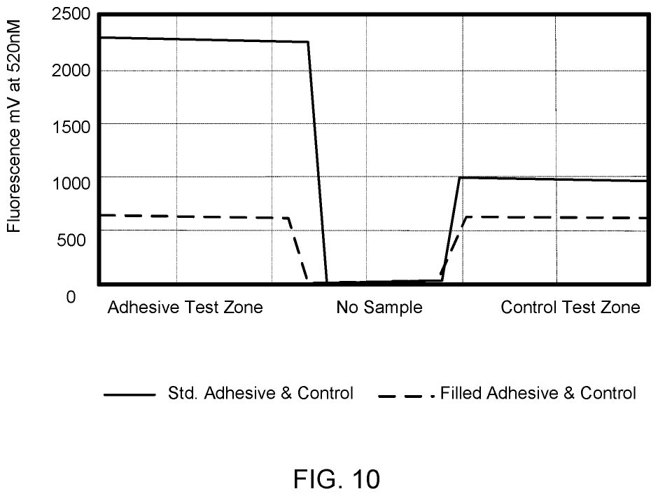

Background fluorescence generated by the adhesives and by the substrate was quantitatively measured using the methodology described above. The background fluorescence generated by the adhesive without a particulate more than doubled that of the base substrate. The background fluorescence generated by the adhesive with the particulate carbon black admixed therein was equivalent to the background fluorescence generated by the substrate material without the adhesive, as illustrated in FIG. 10.

What is claimed is:

1. A microfluidic device, comprising:
a substrate;
an optically translucent lid, wherein the substrate and the lid together define a microfluidic chamber, the microfluidic chamber fluidly coupled to an inlet port and an outlet port;
an adhesive securing the substrate to the lid; and
an optical barrier material between the substrate and the optically translucent lid.

2. The microfluidic device of claim 1, wherein the optical barrier material is in the form of a thin film layer positioned between the adhesive and the lid, in the form of a particulate additive admixed in the adhesive, or a combination thereof.

3. The microfluidic device of claim 2, wherein the thin film layer is present and is a thin film metallic layer including aluminum, tantalum, gold, silver, titanium, zinc, gallium, cadmium, lead, or a combination or alloy thereof.

4. The microfluidic device of claim 2, wherein the thin film layer is present and is a non-metallic thin film layer including silicon, germanium, tellurium, silicon, sulfur, AMTIR glass, or a combination thereof.

5. The microfluidic device of claim 2, wherein the thin film layer is present and has an average thickness from 0.01 μm to 300 μm.

6. The microfluidic device of claim 2, wherein the particulate additive is present and is admixed in the adhesive at a particulate additive to adhesive volume ratio of 1:1,000 to 1:5, wherein the particulate additive includes carbon black, doped boron nitride, polysilicon, or a mixture thereof.

7. The microfluidic device of claim 1, comprising multiple optical barrier materials, wherein the optical barrier material is in the form of a thin film layer positioned between the adhesive and the lid, and wherein a second optical barrier material is in the form a particulate additive admixed in the adhesive.

8. The microfluidic device of claim 1, wherein the microfluidic device further comprises a secondary thin film layer positioned between the adhesive and the substrate.

9. The microfluidic device of claim 1, wherein the lid includes a non-fluorescing material selected from glass, sapphire, silica, plastic, or a combination thereof.

10. The microfluidic device of claim 1, wherein the device further comprises a semiconductor microchip including circuitry positioned electrically interact with fluid when introduced into the microfluidic chamber.

11. A system for conducting a fluorescing biological assay, comprising:
a microfluidic device, including:
a substrate,
an optically translucent lid, wherein the substrate and the lid together define a microfluidic chamber, the microfluidic chamber fluidly coupled to an inlet port and an outlet port,
an adhesive securing the substrate to the lid, and
an optical barrier material between the substrate and the optically translucent lid; and
a fluorescence detector optically coupled to the microfluidic chamber.

12. The system of claim 11, wherein the microfluidic chamber is an elongated chamber having both length to width aspect ratio and a length to height aspect ratio independently at from 2:1 to 200:1.

13. The system of claim 11, wherein the fluorescence detector includes a fluorimeter, photoluminescence spectrometer, an excitation light source, optical filters, or a combination thereof.

14. A method for detecting fluorescence, comprising:
loading a sample and reactants in a microfluidic device, wherein the microfluidic device includes a substrate and an optically translucent lid, the substrate and the lid defining a microfluidic chamber that is fluidly coupled to an inlet port and an outlet port, an adhesive securing the substrate to the lid, and an optical barrier material between the substrate and the optically translucent lid; and
measuring a fluorescence signal generated by positive reaction between the sample and the reactants within the microfluidic chamber.

15. The method of claim 14, wherein the optical barrier material is in the form of a thin film layer positioned between the adhesive and the lid, in the form of a particulate additive admixed in the adhesive, or a combination thereof.
